(19) United States
(12) Patent Application Publication
(10) Pub. No.: US 2007/0271728 A1
(43) Pub. Date: Nov. 29, 2007

(54) Bushing in Dishwasher

(75) Inventor: Sangdeog Byeon, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS, INC., Youngdungpo-gu (KR)

(21) Appl. No.: 10/556,216

(22) PCT Filed: Jul. 12, 2005
(86) PCT No.: PCT/KR05/02238

§ 371 Date: Apr. 2, 2007

(30) Foreign Application Priority Data
Jul. 12, 2004 (KR) P 2004-54028

(51) Int. Cl. H01R 13/10

(52) U.S. Cl. 16/2.5; 134/58 D

(57) ABSTRACT

A bushing in a dishwasher is disclosed. The bushing in a dishwasher according to the present invention includes a hook part having a slot for its extending and contracting in a radial direction of a hole to be detachably inserted into the hole, a packing part formed as one body with the hook part for enhancing a contact force between a first securing member having the hole thereon and a second securing member corresponding to the first securing member, and a stress dispersion recess formed on a boundary portion between the slot and the packing part, extended from the slot toward the packing part for preventing a stress from being concentrated at the boundary portion when the hook part extends and contracts.

### TECHNICAL FIELD

The present invention relates to a dishwasher, and more particularly, to a bushing in a dishwasher capable of securing a reliability of a dishwasher by enhancing an assembling strength thereof in spite of a long time usage.

### BACKGROUND ART

Generally, a dishwasher with a predetermined space therein for washing is provided with a body having an opened front and a door opening/closing the opened front of the body.

Opening/closing the door is required to put or take out the dishes into or from the dishwasher, and a washing process is required to be performed in a state when the door is closed firmly so as to wash the dishes, thereby preventing water leakage of the dishwasher in the washing process.

At this time, a bushing is interposed between the opened front of the body and the door to maintain the state of the door closed firmly.

A related art bushing in a dishwasher will be described referring to the drawings.

FIG. 1 illustrates schematically a perspective view showing a state in that a bushing is provided in a dishwasher according to the related art, and FIG. 2 illustrates a longitudinal section showing an enlarged “A” part in FIG. 1.

Referring to FIG. 1, the related art bushing 20 in a dishwasher is provided on an opened front of a body 10 having a predetermined space therein for washing the dishes.

That is, the bushing 20 is provided on an upper front surface of each side cabinet 11 forming both side surfaces of the body 10.

Referring to FIG. 2, the bushing 20 includes a hook part 21 assembled in a hole 11a on the side cabinet 11, a packing part 22 exposed outside of the side cabinet 11 with which a side of a door is in a close contact when the door is closed.

Then, a slot 23 is formed in a center of the hook part 21 so that the hook part 21 may extend and contract in a radial direction of the hole 11a.

An assembly process of the bushing will be described.

The bushing 20 is placed by means of being inserted in the hole 11a of the side cabinet 11 forcibly.

That is, once inserting the hook part 21 of the bushing 20 into the hole 11a forcibly, the hook part 21 extends and contracts by means of the slot 23 thereof and then is inserted into the hole 11a smoothly.

The busing 21 placed in the hole 11a maintains a fixedly secured state to the hook part 21 hooked on an inner side of the hole 11a unless pulling it out forcibly.

Thus, in case that the door is closed, the side of the door is in a close contact with the packing part 22 of the bushing 20 and then the door may keep the state of being closed firmly.

However, the related art bushing in a dishwasher has a problem that a boundary portion b between the hook part 21 and the packing part 22 is liable to be broken when assembled.

When the bushing 20 is placed in the hole 11a, the hook part 21 extends and contracts, so that a stress is concentrated at the boundary portion b, thereby the boundary portion b liable to be broken.

In other words, the force applied when the hook part 21 extends and contracts is concentrated at the boundary portion b as a rotation moment, thereby causing a problem that the boundary portion b is broken.

Also, since a side of the door 30 pushes and presses the packing part 22 of the hook part 21 when the door 30 is closed, the stress is concentrated further at the boundary portion b between the hook part 21 and the packing part 22, thereby causing the above problem.

### DISCLOSURE OF INVENTION

### Technical Problem

An object of the present invention devised to solve the problem is to provide a bushing in a dishwasher capable of preventing a stress from being concentrated at a boundary portion between a hook part and a packing part after placing the bushing in a hole, thereby enhancing a bushing strength and a bushing life.

### Technical Solution

To achieve this object and other advantages and in accordance with the purpose of the invention, a bushing in a dishwasher according to the present invention comprises a hook part having a slot for its extending and contracting in a radial direction of a hole to be secured detachably on the hole; a packing part for enhancing a contact force between a first securing member having the hole thereon and a second securing member corresponding to the first securing member; and a stress dispersion recess in a boundary portion between the slot and the packing part, extended toward the packing part for preventing a stress from being concentrated at the boundary portion.

The stress dispersion recess is formed to have a length in a perpendicular direction of the hook part's extending and contracting direction, and to have a surface recessed concavely toward the packing part from the slot.

The sectional area of the hook part is formed larger than that of the hole, and the packing part is formed in a shape similar to a circle.

At this time, the hook part and the packing part are made of resin.

In another aspect of the present invention to achieve the object and other advantages and in accordance with the purpose of the invention, the bushing according to present invention in a dishwasher comprising a body having a space for washing the dishes therein and an opened front, a door for opening/closing the opened front of the body, and a bushing for enhancing a contact force of the door once the door closes the opened front of the body, comprises a hook part detachably inserted into a hole on a first side of the opened front of the body and having a slot for its extending and contracting in a radial direction of the hole; a packing part formed as one body with the hook part for enhancing a contact force between the opened front of the body having the hole thereon and the door; and a stress dispersion recess formed on a boundary portion between the slot and the packing part, extended toward the packing part from the slot for preventing a stress from being concentrated at the boundary portion.

The stress dispersion recess is formed to have a length in a perpendicular direction of the hook part's extending and contracting direction, and to have a surface recessed concavely toward the packing part.

The hook part is formed to have an enough size to be inserted into the hole forcibly.

The sectional area of the packing part is larger than that of the hole, and the packing part is formed in a shape similar to a circle.

The hook part and the packing part are made of resin.

### Advantageous Effects

A bushing in a dishwasher according to the present invention has an advantageous effect that the busing is capable of preventing a stress from being concentrated at the boundary portion between the hook part and the packing part, thereby enhancing strength of the bushing.

A bushing in a dishwasher according to the present invention has another advantageous effect that a reliability of a dishwasher is enhanced, because the strength of the bushing is enhanced.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates a perspective view schematically showing a state in that a related art busing in a dishwasher is provided;

FIG. 2 illustrates a longitudinal section enlarged “A” part in FIG. 1

FIG. 3 illustrates a perspective view of a bushing in a dishwasher according to the present invention schematically; and

FIG. 4 illustrates a longitudinal section of key parts schematically showing a state in that a bushing in a dishwasher according to the present invention is placed in a side cabinet.

### BEST MODE FOR CARRYING OUT THE INVENTION

Reference will now be made in detail to the preferred embodiments of the present invention, examples of which are illustrated in the accompanying drawings.

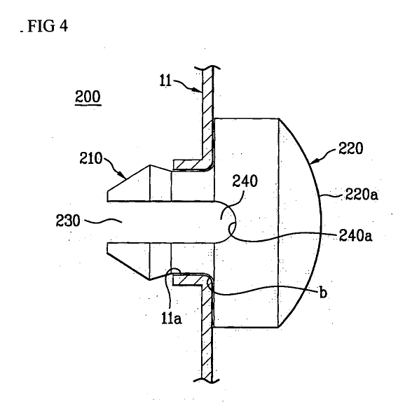

FIG. 3 illustrates a perspective view of a bushing in a dishwasher according to the present invention schematically and FIG. 4 illustrates a longitudinal section of key parts schematically showing a state in that a bushing in a dishwasher according to the present invention is placed in a side cabinet.

Referring to FIG. 3, a bushing 200 according to the present invention in a dishwasher is provided with a hook part 210 having a slot 230, a packing part 220 formed as one body with the hook part 210, and a stress dispersion recess 240 formed in a boundary portion b between the slot 230 of the hook part 210 and the packing part 220.

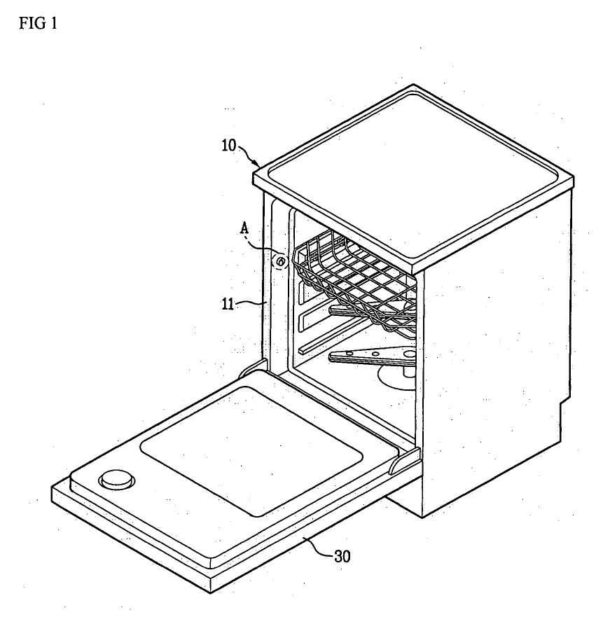

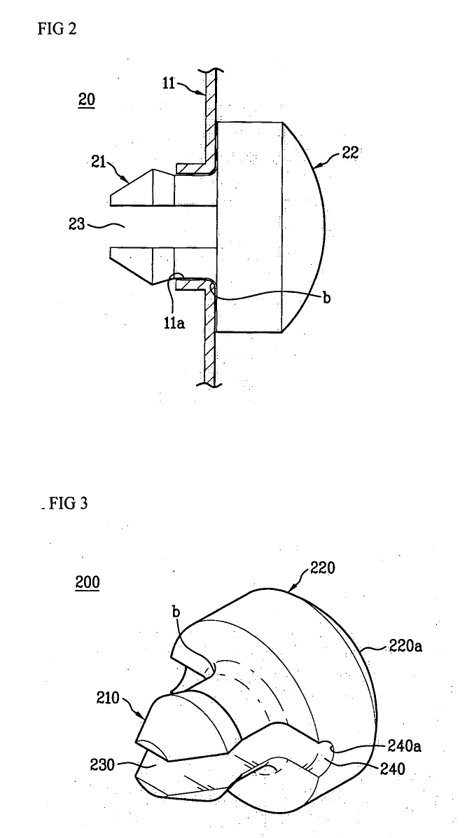

Referring to FIG. 4, the hook part 210 is detachably inserted in a hole 11a formed on each side cabinet 11 (see FIG. 1) in both sides of a body 10.

The slot 230 is formed for the hook part 210 to extend and contract in a radial direction of the hole 11a when the hook part 210 is inserted into or detached from the hole 11a.

Also, the hook part 210 is formed to have an enough size to be inserted into the hole 11a forcibly. That is, the circumference including the slot 230 of the hook part 210 is a little bit lager than that of the hole 11a.

Thus, the hook part 210 extends and contracts by means of the slot 230 and then it is inserted into the hole 11a. After that, a front of the hook part 210 is hooked and secured to an inner end of the hole 11a.

The packing part 220 is formed to enhance a contact force between the side cabinet 11 and the door 30 (see FIG. 1).

That is, the sectional area of the packing part 220 is formed larger than that of the hole 11a on the side cabinet 11 and then the packing part 220 is exposed outside in a state of the hook part 210 secured in an inner side of the hole 11a.

Accordingly, the packing part 220 is in a close contact with a side of the door 30 in case that the door 30 is closed, which enhances a contact force between a front circumference of a side cabinet 11 and a side of the door 30. Therefore, not only a secureness of the door 30 is enhanced in a state of the door 30 being closed but also a water leakage through an aperture between the door 30 and the side cabinet 11 is prevented in a washing process.

An appearance of the packing part 220 may be various but preferably formed in a shape similar to a circle. A side of the packing part 220 in a close contact with the door 30 may be formed concavely so as to minimize an interference caused by a close contact with the door 30 when the door is closed.

The stress dispersion recess 240 is formed to have a length in a perpendicular direction of the hook part's 210 extending and contracting direction, and it is recessed concavely toward the packing part 230 from the slot 230.

When it is inserted into or detached from the hole 11a, the hook part 210 extends and contracts, so that the concentrated stress at the boundary b can be dispersed through the stress dispersion recess 240.

Furthermore, since the hook part 210 and the packing part 220 are made of resin to have elasticity, it is preferred but not necessary that a side of the door 30 is in a close contact with the packing part 220 of the bushing 200 smoothly when the door 30 is closed.

An operation of a bushing in a dishwasher according to a first embodiment of the present invention will be described.

First of all, a bushing 200 is mounted on each side cabinet 11 forming side walls of the body 10 (see FIG. 1).

That is, the busing 200 is mounted as a hook part 210 is inserted into a hole 11a formed on a first front side of the side cabinet 11.

More specifically, as the hook part 210 extends and contracts by means of a slot 230 and at the same time it is inserted into the hole 11a, the busing 200 is mounted. After that, a projected front toward in a radial direction of the hook part 210 is hooked on and secured to an inside of the hole 11a.

Since a stress dispersion recess 240 is formed in a boundary portion b between the slot 230 of the hook part 210 and the packing part 220, the stress concentrated at the boundary portion b may be dispersed, thereby preventing the boundary portion b from being broken.

The stress dispersion recess 240 of the bushing 200 disperses also a stress concentrated at the boundary portion b as a side of the door 30 pushes and presses the packing part 220 of the busing 200 in case that the door is opened or closed, thereby enabling the strength of the bushing 200 to be enhanced against an outer force.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The bushing in a dishwasher according to the present invention may have an industrial applicability, because a stress is prevented from being concentrated at the boundary portion between the hook part and the packing part, and strength of the bushing is enhanced.

Also, the bushing in a dishwasher according to the present invention may have another industrial applicability, because a bushing life is lengthened along with the improvement of the bushing strength, thereby reducing expenses relevant to product maintenance and enhancing a reliability of a dishwasher.

1. A bushing in a dishwasher comprising:
a hook part having a slot for its extending and contracting in a radial direction of a hole to be detachably inserted into the hole;
a packing part formed as one body with the hook part for enhancing a contact force between a first securing member having the hole thereon and a second securing member corresponding to the first securing member; and
a stress dispersion recess formed on a boundary portion between the slot and the packing part, extended from the slot toward the packing part for preventing a stress from being concentrated at the boundary when the hook part extends and contracts.

2. The bushing as claimed in claim 1, wherein the stress dispersion recess is formed to have a length in a perpendicular direction of the hook part's extending and contracting direction.

3. The bushing as claimed in claim 1, wherein the stress dispersion recess has a surface recessed concavely from the slot toward the packing part.

4. The bushing as claimed in claim 1, wherein the hook part is formed to have an enough size to be inserted into the hole forcibly.

5. The bushing as claimed in claim 1, wherein the sectional area of the packing part is formed lager than that of the hole.

6. The bushing as claimed in claim 1, wherein the packing part is formed in a shape similar to a circle.

7. The bushing as claimed in claim 1, wherein the hook part and the packing part are made of resin.

8. A dishwasher comprising:
a body;
a space therein for washing the dishes and an opened front;
a door for opening/closing the opened front of the body; and
a busing provided on a first side of the opened front of the body for enhancing a contact force of the door when the door closes the opened front of the body comprising:
a hook part having a slot for its extending and contracting in a radial direction of a hole to be detachably inserted into the hole;
a packing part formed as one body with the hook part for enhancing a contact force between a first securing member having the hole thereon and a second securing member corresponding to the first securing member; and
a stress dispersion recess formed on a boundary portion between the slot and the packing part, extended from the slot toward the packing part for preventing a stress from being concentrated at the boundary portion when the hook part extends and contracts.

9. The dishwasher as claimed in claim 8, wherein the stress dispersion recess is formed to have a length in a perpendicular direction of the hook part's extending and contracting direction.

10. The dishwasher as claimed in claim 8, wherein the stress dispersion recess has a surface recessed concavely from the slot toward the packing part.

11. The dishwasher as claimed in claim 8, wherein the hook part is formed to have an enough size to be inserted into the hole forcibly.

12. The dishwasher as claimed in claim 8, wherein the sectional area of the packing part is formed lager than that of the hole.

13. The dishwasher as claimed in claim 1, wherein the packing part is formed in a shape similar to a circle.

14. The dishwasher as claimed in claim 1, wherein the hook part and the packing part are made of resin.
